(19) United States
(12) Patent Application Publication
(10) Pub. No.: US 2017/0300937 A1
(43) Pub. Date: Oct. 19, 2017

(54) SYSTEM AND METHOD FOR INFERRING SOCIAL INFLUENCE NETWORKS FROM TRANSACTIONAL DATA

(71) Applicant: BiddRocket, Inc., Mobile, AL (US)

(72) Inventors: Brian Ley, San Francisco, CA (US); Ashton Verdery, University Park, PA (US)

(21) Appl. No.: 15/488,284

(22) Filed: Apr. 14, 2017

Related U.S. Application Data
(60) Provisional application No. 62/323,040, filed on Apr. 15, 2016.

(51) Int. Cl. G06Q 30/02; G06Q 50/00

(52) U.S. Cl. CPC G06Q 30/0201; G06Q 50/01

(57) ABSTRACT

A system and method for inferring social influence networks from transactional data are provided. Raw transactional data having transaction entries reflecting customer transactions is provided to a processor and translated into internal data. Computer nodes within the system draw a number of randomized samples from the internal data based on a sample number and sample size determined by the processor to promote computational efficiency and accuracy. The computer nodes create a social influence network having links therein representing inferred customer-to-customer purchasing influence. The processor aggregates the social influence network of each sample to create a global social influence network that evidences the purchasing influence of customers within the raw transactional data. The processor may assign a social influence value to customers represented within the raw transactional data by analyzing the global social influence network.

### CROSS-REFERENCE TO RELATED APPLICATIONS

This application claims priority to U.S. Provisional Patent Application No. 62/323,040, entitled “Tools for Implementation of Scalable Randomization Algorithms for Inferring Social Influence Networks from Time Stamped Business Transactions,” filed Apr. 15, 2016, which application is incorporated herein in its entirety.

### FIELD OF THE DISCLOSURE

The subject matter of the present disclosure refers generally to a system and method for inferring social influence networks from transactional data.

### BACKGROUND

In recent years, the use of social network analysis has increased in popularity and is now widely used in many business applications. Companies are utilizing online and digitized data to map out social network connections existing between former and current customers as well as connections between current customers and potential customers. Based on the mapped connections, companies can devise refined marketing campaigns, personalization efforts, and customer retention programs.

Conventionally, the data used to map social connections is derived from, or relates to, online interactions between customers. However, many companies lack access to or are unable to derive meaningful social network connections from such data. This can be because a company lacks clear data on customer identities, few of its customers order online, or simply because a company's business model does not rely on or include a social networking or social media platform. Accordingly, many companies can only benefit from social network analysis by using systems and methods which can infer off-line social network connections, i.e., systems and methods that do not rely on online social networking or social media data. Specifically, systems and methods that utilize a limited number of inputs that a large number of companies are likely to have, such as raw transaction logs, may prove particularly valuable given their capacity to apply to a large number of industries, business sectors, and companies.

Although there are several known techniques that may be implemented to translate transactional data into social network connections amongst customers, known techniques are generally limited with respect to the types of connections they establish and/or cannot be scaled to accommodate data sets having millions of entries therein. One such known technique is collaborative filtering. Companies often use collaborative filtering to recommend additional products to customers based on the assumption that a customer who purchases product “A” would be interested in purchasing other products bought by previous customers who also bought product “A”. Collaborative filtering may also be used to make automated inferences that two customers who purchased the same product are linked or connected in some social sense. Although collaborative filtering may be applied to large data sets, this technique is overly reliant on shared customer interest and cannot differentiate between social connections based on product orientation from connections based on social influence. That is, collaborative filtering generally cannot distinguish instances where one customer has influenced another customer's purchase of a product from instances where two customers merely have a shared interest in a product and independently purchased it without being influenced. Latent space techniques, which categorize customers based on their similarity in attributes or actions in a latent space and take the distance between customers in the latent space as an inverse weighted social network link, are similarly unable to identify social influence amongst customers. Thus, collaborative filtering and latent space techniques generally provide little understanding of the social influence any one customer may have over another customer and often produce network connections attributable to latent homophily.

Other known techniques which may be implemented to infer social network connections include exponential random graph modeling and epidemiological modeling. Exponential random graph modeling uses structural features of data and theories of social interaction to estimate influence links between customers, and epidemiological modeling focuses on the temporal patterns of individual infection to infer trajectories through which a disease may spread to a large number of individuals. Traditionally, epidemiological modeling focused on the spread of disease. More recently, however, epidemiological modeling has been used in applications to assess the transmission of digital information. However, due to their computational intensity, both exponential random graph and epidemiological modeling are incapable of analyzing data sets having millions of entries therein within a time frame suitable for commercial applications. Therefore, such techniques cannot scale to accommodate and process large data sets generally commensurate in size to the transactional data often possessed by large companies.

Accordingly, a need exists in the art for a scalable system and method capable of translating transactional data into meaningful social networks indicative of social influence amongst customers.

### SUMMARY

A system and method for inferring social influence networks from transactional data are provided. Generally, the system and method of the present disclosure are designed to generate a global social influence network that evidences the social influence customers within a raw transactional data set have on one another in terms of purchasing influence. The method steps and the operations performed by the system of the present disclosure are generally divided into three stages: a pre-processing, a processing, and post-processing stage.

During the pre-processing stage, a transactional data set comprising a plurality of transaction entries, each having a customer, product, and transaction time associated therewith, is provided to a processor and translated into a corresponding internal data set. The internal data set comprises a plurality of internal entries, each internal entry having a customer identifier with a product identifier and a transaction time identifier associated therewith. A plurality of randomized samples is drawn from the internal data set. The number of samples drawn (S) and the size of each sample (K)—the number of different customer identifiers present within a sample—are determined by the processor. The processor preferably determines the S value based on the number of customer identifiers within the internal data set, the K value, and a defined average number of times in which any given two customer identifiers must appear within a sample across the drawn samples. The processor preferably determines the K value based on the number of different customer identifiers within the internal data set.

Once the processor determines the S and K values, a plurality of samples equal to S are randomly drawn from the internal data set. Each sample drawn has a number of different customer identifiers therein equal to K and the product and transaction time identifiers associated therewith. To make the sampling process more efficient, the plurality of samples is preferably drawn by a plurality of computer nodes operably connected to the processor. Accordingly, in the foregoing ways, the pre-processing stage of the system and method of the present disclosure effectively breaks down and samples raw transactional data in a manner that facilitates both computational efficiency and accuracy during processing. In turn, such computational efficiency enables the system and method of the present disclosure to process data sets having millions of data entries therein, thereby improving upon known systems and methods, which are generally limited in processing capacity to tens or hundreds of thousands of data entries.

Each sample drawn during pre-processing is subsequently processed preferably by the plurality of computer nodes during the processing stage. During processing, the plurality of computer nodes create a social influence network for each sample based on the customer, product, and transaction time identifiers present within the respective samples. Each social influence network has zero or more influence links extending between customer identifiers. Influence links extending from one customer identifier to another represent an inferred social influence one customer has over another customer in terms of purchasing influence, i.e., an inference that one customer has influenced another customer's purchase. In this way, the social network connections established by the system and method of the present disclosure enables greater insight regarding social influence within a network than collaborative filtering and latent space techniques.

During the post-processing stage, the social influence networks created by the plurality of computer nodes are aggregated by the processor to establish a global social influence network. In a preferred embodiment, the global social influence network has all of the influence links present within each social influence network therein. In another preferred embodiment, the processor may filter out certain influence links that do not meet certain defined criteria. Using the global social influence network, the processor may analyze influence links to determine a social influence value for customer identifiers and subsequently generate reports reflecting the same. The social influence values determined by the processor reflect the degree of purchasing influence a customer identifier has over other customer identifiers within the network. Because each customer identifier corresponds to a customer within the raw transactional data set, the social influence values determined for the customer identifiers are reflective of the purchasing influence of the customers within the raw transactional data set.

To carry out the various operations disclosed above, the system of the present disclosure generally comprises a processor, a plurality of computer nodes operably connected to the processor, and a non-transitory computer-readable medium coupled to the processor. The non-transitory computer-readable medium has instructions stored thereon, which, when executed by the processor, cause the system to perform operations disclosed herein.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a block diagram illustrating how a social influence network may be inferred from a transactional data set in a manner consistent with the principles of the present disclosure.

FIG. 2 is a block diagram illustrating a system embodying features consistent with the principles of the present disclosure receiving a transactional data set consistent with the principles of the present disclosure.

FIG. 3 is a diagram illustrating certain method steps and system features consistent with the principles of the present disclosure.

FIG. 4 is a diagram illustrating certain method steps and system features consistent with the principles of the present disclosure.

FIG. 5 is a diagram illustrating certain method steps and system features consistent with the principles of the present disclosure.

FIG. 6 is a flowchart illustrating certain pre-processing steps consistent with the principles of the present disclosure.

FIG. 7 is a flowchart illustrating certain processing steps consistent with the principles of the present disclosure.

FIG. 8 is a flowchart illustrating certain post-processing steps consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “created vector” and grammatical equivalents refers to the one or more vectors created by the processor based on the mapped activation levels of the one or more sensors.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As used herein, the term “program” and grammatical equivalents thereof are understood to mean “a sequence of programming instructions describing how to perform a certain task.”

As will be evident from the disclosure provided below, the present invention satisfies the need for a scalable system and method capable of translating transactional data into meaningful social networks indicative of social influence amongst customers.

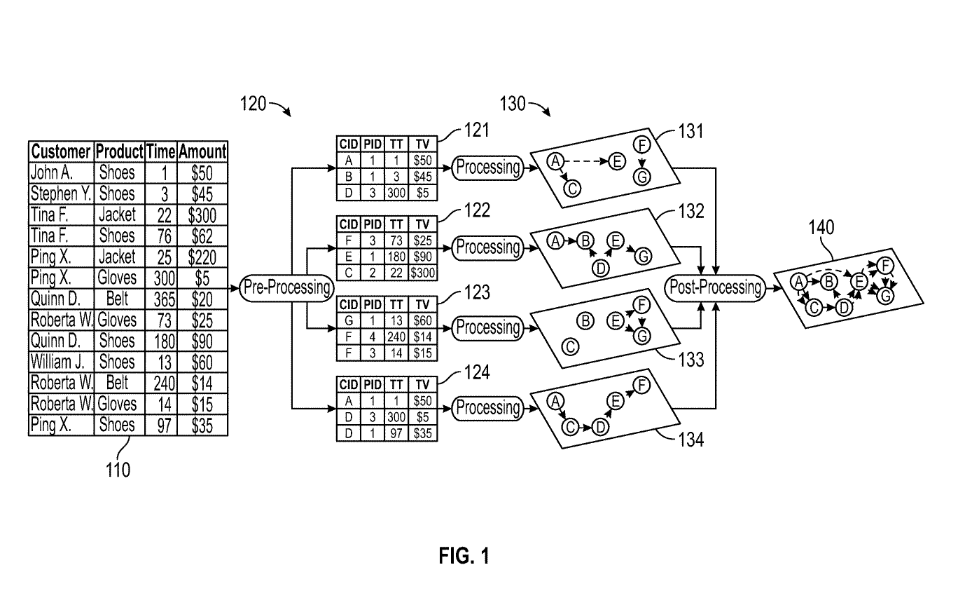

Turning now to the drawings, FIGS. 1-8 illustrate preferred embodiments of a system and method, or certain components or steps thereof, for inferring social influence networks from transactional data. FIG. 1 is a block diagram providing a general overview of the process through which a global social influence network 140 may be generated from a raw transactional data set 110 using the system 200 and method of the present disclosure. As shown FIG. 1, method steps of the method and the operations performed by the system 200 of the present disclosure are generally divided into three stages: a pre-processing, a processing, and a post-processing stage. It is understood that the various method steps associated with the method of the present disclosure may be carried out as operations by the system 200 of the present disclosure.

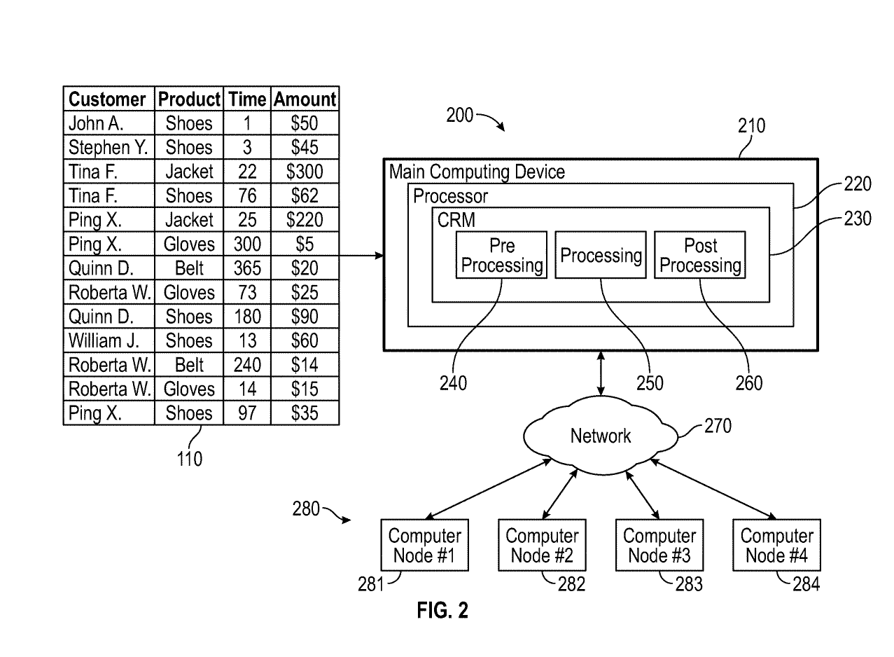

FIG. 2 shows one preferred embodiment of the system 200 receiving a raw transactional data set 110. As shown in FIG. 2, the system 200 generally comprises a processor 220 and a plurality of computer nodes 280 operably connected to the processor 220. The processor 220 is configured to perform the operations disclosed herein based on programming instructions stored within the system 200. The processor 220 may be any processor or microprocessor suitable for executing such program instructions. In some embodiments, the processor 220 may have a memory device therein suitable for storing the data, samples, and/or networks disclosed herein. In a preferred embodiment, as shown in FIG. 2, the processor 220 may be a component of a computing device 210. Computing device 210 may be any digital computer or mobile computing device including, but not limited to, laptops, desktops, workstations, personal digital assistants, servers, mainframes, cellular telephones, smart phones, tablet computers, or other similar devices. Accordingly, the inventive subject matter disclosed herein, in full or in part, may be implemented or utilized in devices including, but not limited to, laptops, desktops, workstations, personal digital assistants, servers, mainframes, cellular telephones, smart phones, tablet computers, or other similar devices. One of skill in the art will, however, appreciate that certain actions or operations carried out by the processor 220, as disclosed herein, may alternatively be carried out through other suitable methods, such as through various cloud computing applications.

The plurality of computer nodes 280 are configured to perform the various pre-processing and processing operations disclosed herein. The computer nodes 281-284 within the plurality of computer nodes 280 may be any type of processor or other similar device suitable for executing such operations. As shown in FIG. 2, the plurality of computer nodes 280 may be operably connected to the processor 220 wirelessly via a network 270 or other similar wireless connection. Alternatively, the plurality of computer nodes 280 may be operably connected to the processor 220 through one or more wired connections. Each computer node 281-284 within the plurality of computer nodes 280 may have its own memory operably connected to or associated therewith. In such embodiments, any communication between the plurality of computer nodes 280 and the processor 220 may be facilitated through a message-passing interconnection network 270. Alternatively, the plurality of computer nodes 280 and the processor 220 may share a common memory, which facilitates communication between the processor 220 and the plurality of computer nodes 280.

In a preferred embodiment, the programming instructions responsible for the operations carried out by the processor 220 and the plurality of computer nodes 280 are stored on a non-transitory computer readable medium 230 that is coupled to the processor 220, as shown in FIG. 2. Alternatively, the programming instructions may be stored or included within the processor 220. Examples of non-transitory computer-readable mediums 230 include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. As shown in FIG. 2, in some embodiments, the programming instructions may be stored as modules within the non-transitory computer readable medium 230. In one preferred embodiment, the programming instructions responsible for pre-processing, processing, and post-processing operations, as described herein, may define a pre-processing module 240, a processing module 250, and a post-processing module 260, respectively, within the non-transitory computer readable medium 230.

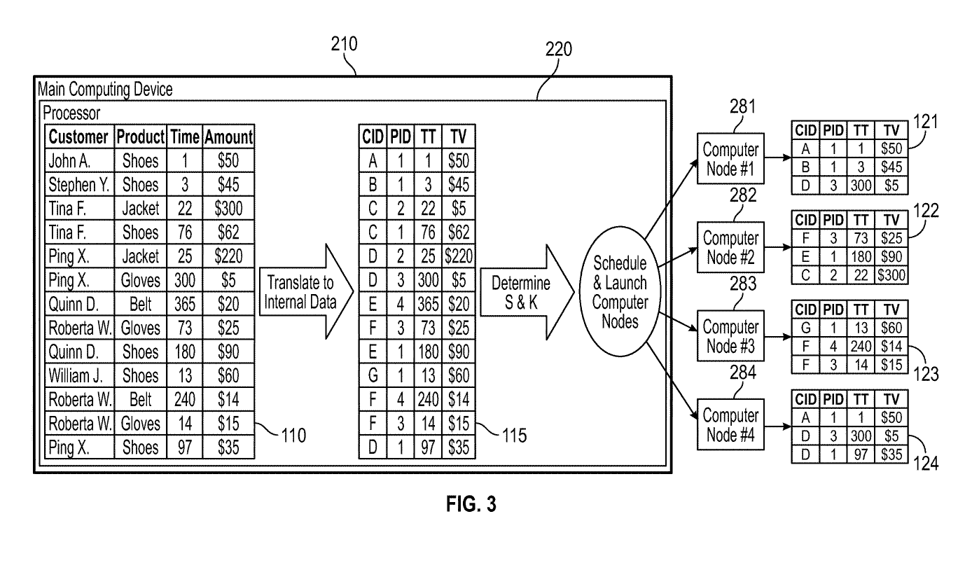

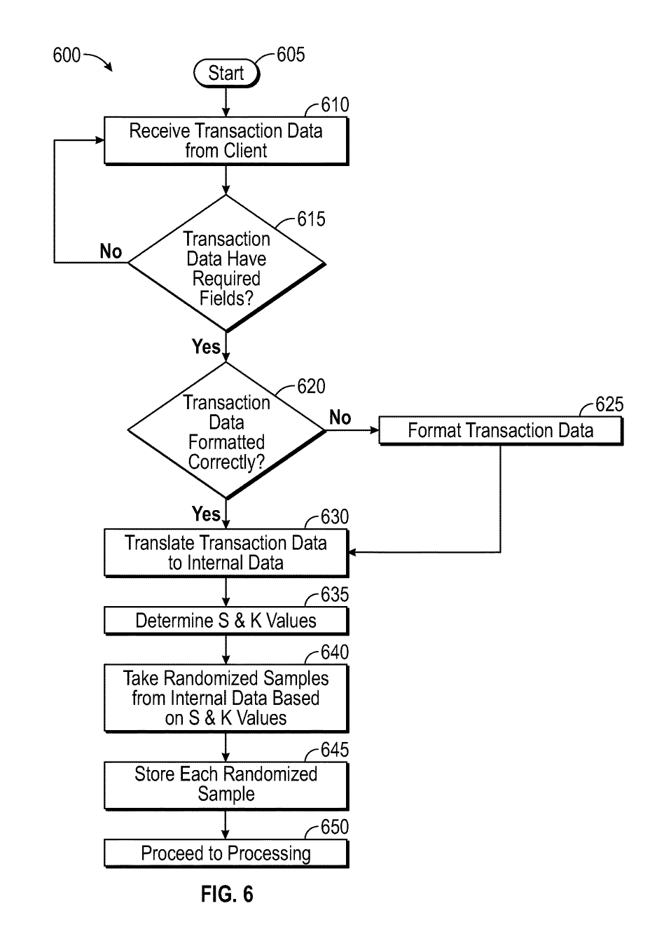

FIGS. 6-8 provide a series of flow charts representing various method steps carried out during the pre-processing, processing, and post-processing stages, respectively, of the method of the present disclosure. FIGS. 3-5 illustrate the method steps provided in FIGS. 6-8 being carried out as operations by the system 200 of the present disclosure.

FIG. 6 illustrates a flow chart 600 showing certain method steps that may be carried out during the pre-processing stage of the present method. Step 605 indicates the beginning of the pre-processing stage of the method of the present disclosure. In data acquisition step 610, a transactional data set 110 is provided to and subsequently received by the processor 220. As shown in FIGS. 1-3, the transactional data set 110 provided to the processor 220 preferably comprises a plurality of transaction entries, wherein each transaction entry is indicative of an individual customer transaction. As further shown in FIGS. 1-3, each transaction entry preferably has a customer, a product, and a transaction time therein. The customer information associated with a transaction entry may represent an individual, group, company, organization, or any other entity. Additional information, such as product price, as shown in FIGS. 1-3, may be included within the transaction entries without disrupting the method steps and system operations disclosed herein. The processor 220 preferably analyzes the transactional data set 110 to ensure each transaction entry within the transactional data set 110 has a customer, a product, and a transaction time associated therewith in field verification step 615. In the event one or more transaction entries lack a customer, a product, and/or a transaction time, the processor 220 may require the entity supplying the transactional data set 110 to correct, edit, and/or resubmit the transactional data set 110.

Once the processor 220 verifies each transaction entry has a customer, product, and transaction time, the processor 220 may analyze the transactional data set 110 to ensure each transaction entry is formatted correctly in format verification step 620. In a preferred embodiment, the system 200 and method of the present disclosure may require the transactional data set 110 to be in an itemized format such that each transaction entry has a single customer, product, and transaction time therein. However, one of skill in the art will appreciate that the system and method of the present disclosure may permit other transactional data formats. Such other formats may include, but are not limited to, a “shopping cart” format wherein an individual transaction entry has a customer having multiple products and/or transaction times associated therewith. In the event the processor 220 determines the transactional data set 110 is in a format different from the one required by the method and system 200 of the present disclosure, the processor 220 may re-format the transactional data set 110 into the correct format in format correction step 625.

To facilitate use of the transactional data set 110 within certain programs disclosed herein, the transactional data set 110 may be translated into an internal data set 115 in translation step 630, as shown best in FIGS. 3 and 6. The internal data set 115 comprises a plurality of internal entries, wherein each internal entry corresponds to a transaction entry within the transactional data set 110. Preferably, each internal entry has a customer identifier with a product identifier and a transaction time identifier associated therewith. Each customer identifier, product identifier, and transaction time identifier within the internal data set 115 corresponds to a customer, a product, and a transaction time within the transactional data set 110, as best shown in FIG. 3. For instance, a transaction entry representing a customer named “John A.” purchasing a pair of shoes may be translated into an internal entry having a customer identifier of “A” and a product identifier of “1.” In some embodiments, transaction times within the transactional data set 110 may be reformatted or converted into different units of time in translation step 630. As shown in FIG. 3, in one preferred embodiment, the customer identifier may be alphabetic while the product identifier and transaction time identifier are numeric. However, one of skill in the art will appreciate that the customer identifiers, product identifiers, and/or transaction time identifiers within the internal data set 115 may be any individual or grouped combination of letters, numerals, symbols, or any combination thereof. In alternative embodiments, certain methods, operations, and/or programs described below may be used that utilize the transactional data set 110 in its original form, thereby rendering translation step 630 as optional.

In step 635, the processor 220 determines a number of samples (S) to be drawn from the internal data set 115 and a sample size (K) for each sample drawn, as shown in FIGS. 3 and 6. To facilitate computational efficiency and the ability to scale to any size data set, the processor 220 determines the S value based, in part, on the number of different customer identifiers (N) within the internal data set 115. For instance, the internal data set 115 shown in FIG. 3 has a total of seven different customer identifiers therein (customer identifiers A-G), and thus has an N value of seven. To ensure that any given pair of customer identifiers, such as A and B, C and E, etc. appear in enough samples together to accurately infer an influence link, or lack thereof, between the customer identifiers, the processor 220 may also determine the S value based on a defined average number of times (X) in which two customer identifiers must appear together within a sample across all samples. For instance, an X value of fifty provides fifty samples that can be subsequently evaluated during processing and post-processing to determine whether, for example, customer identifier A has a social influence over customer identifier B, or vice versa. The X value may be determined by a user and programmed into the system or may be determined by the processor 220 during step 635. In one preferred embodiment, the X value is at least thirty. However, it is understood that the X value may be greater or less than thirty depending on the N value of an internal data set 115.

The S value is also preferably based on the sample size (K), wherein K represents the number of different customer identifiers, and thus customers, that will be present within any given sample drawn from the internal data set 115. In a preferred embodiment, the processor 220 determines the K value based on the N value of the internal data set 115. Increasing the K value generally serves to increase processing efficiency during the processing stage of the method disclosed herein more so than increasing the S value. Accordingly, in some embodiments, the K value may be maximized relative to the N value such that the K value equals the N value. However, depending upon the social influence program utilized during the processing stage, processing efficiency may decrease upon the K value reaching a certain threshold. In such embodiments, the processor 220 may select a K value based on the threshold of the social influence program. For instance, the NETINF social influence program disclosed below may support a K value of approximately fifty thousand before experiencing a decrease in processing efficiency. Thus, in this example, the processor 220 would select a K value equal to fifty thousand. In some embodiments, the processor 220 may utilize a machine learning technique trained via backtesting on transactional data sets having known social influence networks therein to determine S and K values.

Once the processor 220 has determined an S and K value, the plurality of computer nodes 280 draws a plurality of randomized samples 120 from the internal data set 115 in step 640 based on the S and K values determined in step 635, as shown in FIGS. 3 and 6. The plurality of samples 120 may be drawn by the plurality of computer nodes 280 using any suitable sampling technique including, but not limited to, stratified, antithetic, or Latin hypercube sampling. The number of samples drawn by the plurality of computer nodes 280 is equal to S, and the number of different customer identifiers within each sample is equal to K. Each sample 121-124 within the plurality of randomized samples 120 has the product identifiers and transaction time identifiers associated with each customer identifier present within the sample. In some instances, each sample 121-124 may also include other identifiers, e.g., amount identifiers, associated with the customer identifiers. As shown in FIG. 3, the step of drawing a plurality of samples from the internal data set 115 may involve the processor 220 scheduling and launching the plurality of computer nodes 280 to draw the plurality of randomized samples 120. The processor 220 may schedule the plurality of computer nodes 280 using first-in-first-out scheduling, without head-of-line blocking, tiling, or any other known scheduling technique.

The manner in which the plurality of computer nodes 280 selects samples from the internal data set 115 may be governed by a randomization program within the non-transitory computer readable medium 230, the network 270, or on or within any other device or service that is accessible by the plurality of computer nodes 280. Preferably, when drawing the plurality of randomized samples 120, the plurality of computer nodes 280 draws customer identifiers and the product and transaction time identifiers associated therewith, without replacement. That is, it is preferred that the samples are drawn such that no internal entry from the internal data set 115 is repeated within a drawn sample, as shown in samples 121-124 in FIGS. 1 and 3-4. However, across samples, it is generally preferred that the customer identifiers and the product and transaction time identifiers associated therewith are drawn with replacement. That is, the same internal entry may be repeated across samples, as shown best by samples 121 and 124 in FIGS. 1 and 3-4.

Based on the preferred values and sampling methods disclosed above, the manner in which the processor 220 determines the S value may be represented by S=X/[(K(K−1))/(N(N−1))]² for internal data sets having smaller N values, and, more simply, S=X/(K/N)² for internal data sets having larger N values. For instance, using a NETINF social influence program, if an X value of fifty is selected for an internal data set 115 having one million different customer identifiers therein, the processor 220 will determine an S value of twenty thousand (S=50/(50,000/1,000,000)²). Thus, in the foregoing example, the plurality of computer nodes 280 will draw a total of twenty thousand samples from the internal data set 115, wherein each sample has fifty thousand different customer identifiers and their associated product and transaction time identifiers therein.

Once the plurality of randomized samples 120 are drawn by the plurality of computer nodes 280, each sample 121-124 may be stored within the processor 220 in step 645. Alternatively, each sample 121-124 may be stored within the non-transitory computer readable medium 230 or on some other device or network to which the processor 220 may access each sample 121-124 for later use. In some instances, a local copy of each sample 121-124 may be stored on a memory device associated with the plurality of computer nodes 280. Step 650 indicates the end of the pre-processing stage.

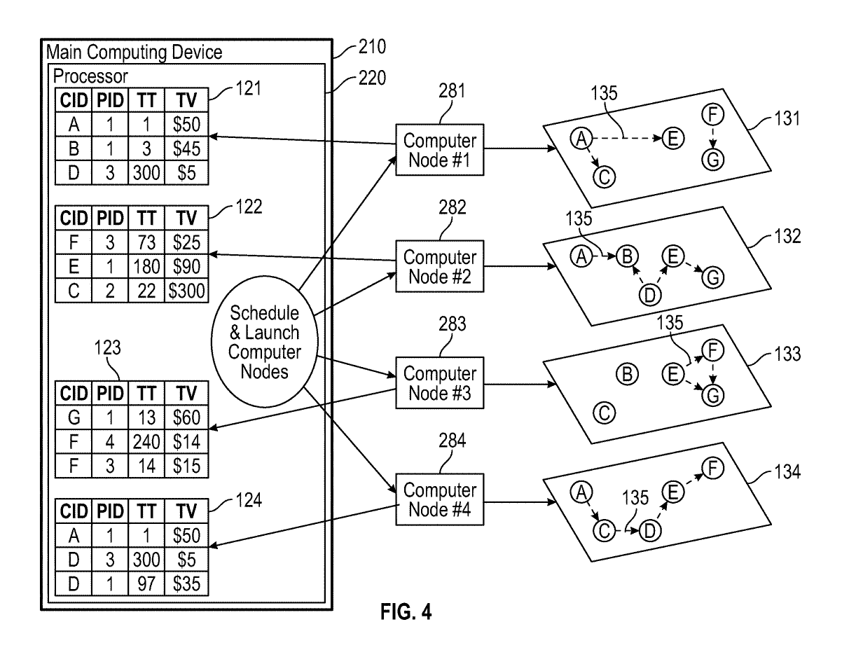

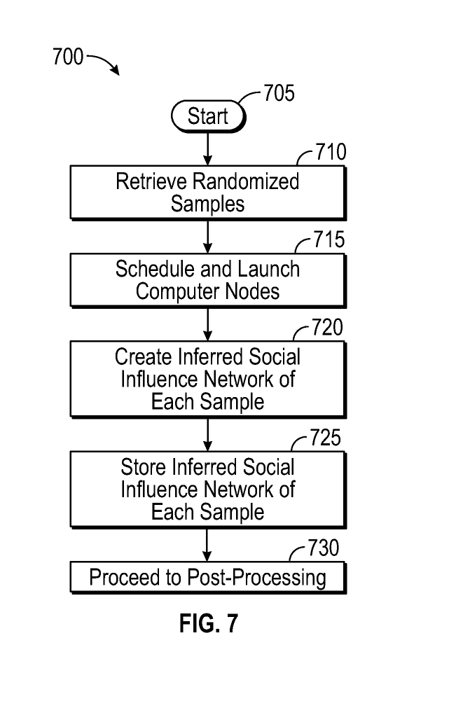

FIG. 7 illustrates a flow chart 700 showing certain method steps that may be carried out during the processing stage of the present method. Step 705 indicates the beginning of the processing stage. As shown in FIGS. 4 and 7, in some embodiments, the plurality of computer nodes 280 may first retrieve the plurality of randomized samples 120 in sample retrieval step 710 before each sample 121-124 is processed. However, it is understood that the present disclosure contemplates alternative embodiments wherein the plurality of computer nodes 280 may immediately process the plurality of randomized samples 120 in step 720 upon drawing the samples 121-124 from the internal data set 115.

In step 720, the plurality of randomized samples 120 are processed to create a plurality of social influence networks 130. As shown in FIG. 4, a social influence network 131-134 is created for each sample 121-124 drawn during pre-processing. Each social influence network 131-134 has customer identifiers therein corresponding to the customer identifiers present within the samples 121-124 from which the social influence network is derived. It is understood that the customer identifiers and the product, transaction time, and amount identifiers associated therewith in samples 121-124 merely serve as examples and do not necessarily reflect the customer identifiers or influence links 135 present within the social influence networks 131-134 shown in FIG. 4.

As further shown in FIG. 4, each social influence network 131-134 has zero or more influence links 135 therein extending between customer identifiers. Each influence link 135 represents an inference made during processing that one customer has socially influenced another customer in terms of purchasing influence. That is, each influence link 135 represents an inference that one customer has influenced another customer's purchase of a product. For instance, the influence links 135 extending from customer identifier A within social influence networks 131-134 in FIG. 4 represent a series of inferences that indicate customer identifier A has influenced customer identifier's B, C, and E to purchase a product. The lack of an influence link 135 extending either to or from a customer identifier, such as customer identifiers B and C in social influence network 133, represents that the customer represented by that customer identifier was not socially influenced in making a purchase nor did they influence other customers to make a purchase.

To create social influence networks 131-134 for each sample 121-124, the method and system of the present disclosure use a social influence program. The social influence program creates inferred influence links 135 between customer identifiers within a sample based on the customer identifiers, product identifiers, and transaction time identifiers therein. Preferably, the social influence program is epidemiological-based. In one preferred embodiment, the social influence program may be the NETINF program, or a variation thereof, disclosed within the publication: M. Gomez-Rodriguez, J. Leskovec, A. Krause. Inferring Networks of Diffusion and Influence. In Proceedings of the 16^{th} ACM SIGKDD international conference on Knowledge Discovery and Data Mining, A C M, 2010. One of skill in the art will appreciate, however, that other social influence programs suitable for creating social influence networks based on customer identifiers, product identifiers, and transaction time identifiers, as disclosed herein, may be used without departing from the inventive subject matter of the present disclosure.

To reduce the processing time required to process the plurality of randomized samples 120, the plurality of randomized samples 120 are preferably processed in step 720 via parallel computing using the plurality of computer nodes 280. In one preferred embodiment, each sample 121-124 of the plurality of randomized samples 120 are processed independently from one another on separate computer nodes 281-284, as shown in FIG. 4. In such embodiments, the social influence program may be implemented on the plurality of computer nodes 280 and subsequently launched by the processor 220. Accordingly, in some embodiments, the processing stage may further involve a step of scheduling and launching computer nodes 715, as shown in FIGS. 4 and 7. The processor 220 may schedule the plurality of computer nodes 280 using first-in-first-out scheduling, without head-of-line blocking, tiling, or any other known scheduling technique. In a preferred embodiment, the social influence network 131-134 for each sample 121-124 is stored within the processor 220 in step 725. Alternatively, social influence network 131-134 may be stored within the non-transitory computer readable medium 230 or on some other device or network to which the processor 220 may access for later use. Step 730 indicates the end of the processing stage.

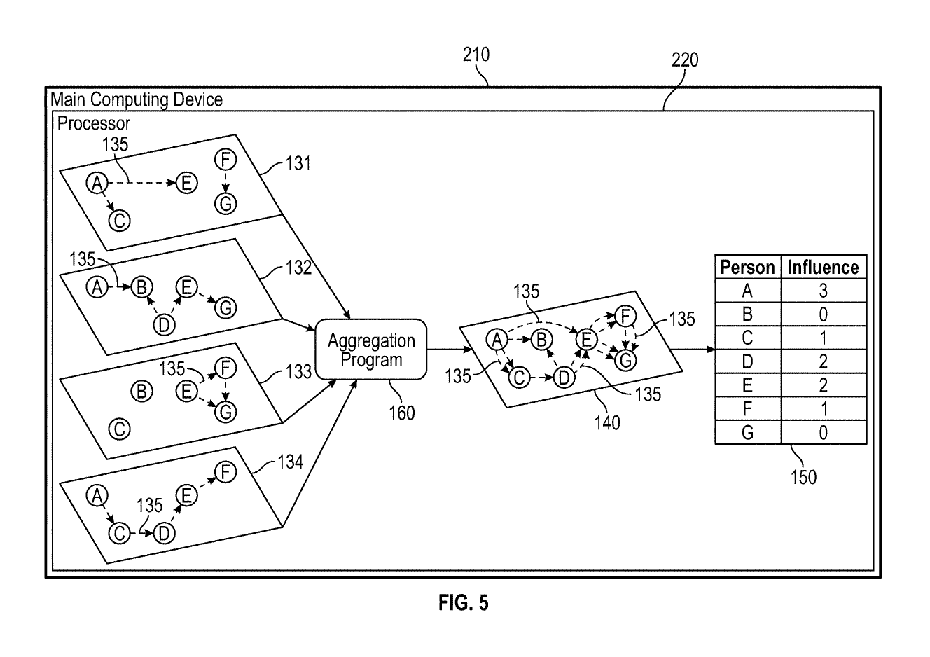

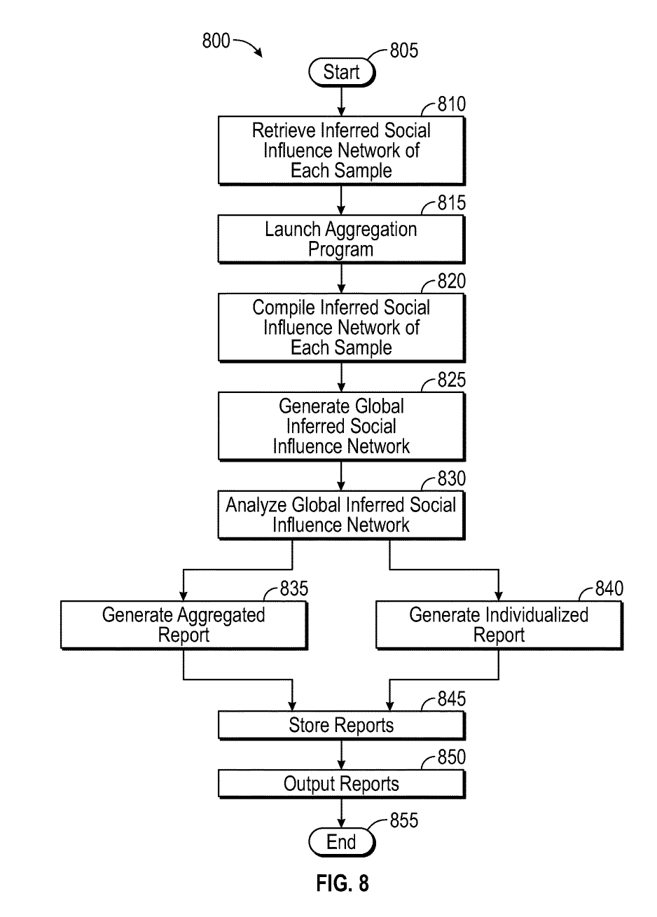

FIG. 8 illustrates a flow chart 800 showing certain method steps or operations that may be carried out during the post-processing stage of the present method and system disclosed herein. Step 805 indicates the start of the post-processing stage. In one preferred embodiment, the post-processing stage begins with the processor 220 retrieving each social influence network 131-134. Once retrieved, the processor 220 launches an aggregation program 160 configured to aggregate the plurality of social influence networks in step 815, as shown in FIGS. 5 and 8.

Once the aggregation program 160 is launched, the processor 220 compiles each of the social influence networks 131-134 in step 820 and subsequently generates a global social influence network 140 therefrom in step 825, as shown in FIGS. 5 and 8. In a preferred embodiment, the global social influence network 140 has all of the customer identifiers and influence links 135 present within each social influence network 131-134 therein, as best shown in FIG. 5. Alternatively, the aggregation program 160 may cause the processor 220 to filter out certain influence links 135 when aggregating the social influence networks 131-134 such that influence links not meeting a defined criteria are not present within the global social influence network 140. In one such embodiment, the aggregation program 160 may cause the processor 220 to filter out influence links 135 which were not inferred a defined number of times across the plurality of social influence networks 130. For instance, the processor 220 may filter out all social inference links 135 between two customer identifiers that were not inferred at least ten times across the plurality of social influence networks 130. In yet another embodiment, the aggregation program 160 may cause the processor 220 to filter out certain customer identifiers and the influence links 135 associated therewith. For instance, the aggregation program 160 may cause the processor 220 to only include the top ten thousand customer identifiers who had the most inferred influence links extending therefrom within the global social influence network 140. Once created, the global social influence network 140 may be stored within the system 200 for later use or outputted to a user interface operably connected to the processor 220 or to an external computing device via a wired or wireless connection.

In a preferred embodiment, the post-processing stage of the present disclosure further comprises a social network analysis step 830. In this step, the processor 220 preferably analyzes the global social influence network 140 and subsequently determines an influence value for at least one customer identifier therein based on the influence links 135 present within the global social influence network 140. In another preferred embodiment, the processor 220 determines a social influence value for all customer identifiers within the global social influence network 140. The processor 220 may determine social influence values based on the number of different customer identifiers a given customer identifier directly or indirectly influences, depending on the intended application. Although social network analysis step 830 is generally discussed herein as being carried out by the processor 220, one of skill in the art will appreciate that the global social influence network 140 may be exported and analyzed outside of the system 200 disclosed herein without departing from the inventive subject matter of the present disclosure.

Using the influence values, the processor 220 may generate a report 150. As shown in FIG. 8, the processor 220 may generate an aggregated report containing the social influence of each customer identifier within the global social influence network 140 in step 835 or an individualized report containing the social influence value of a single customer identifier in step 840, or both. As shown in FIG. 5, in one preferred embodiment, social influence values are numerical. However, one of skill in the art will appreciate that social influence values may be represented as alphabetical, alphanumeric, symbol-based, or any combination thereof.

The report 150 generated by the processor 220 may express social influence values in reference to customer identifiers, as shown in FIG. 5. In another preferred embodiment, the processor 220 may translate the customer identifiers back to the customer format they correspond to within the transactional data set 110, e.g., translating customer identifier C to “Tina F.,” before generating a report 150. Alternatively, the processor 220 may generate two reports, one displaying customer identifiers and the other displaying customers as originally provided within the transactional data set 110. The processor 220 may limit the customer or customer identifiers and social influence values associated therewith represented within a report 150 based on the social influence values and/or confidence values, as disclosed below, determined by the processor 220.

In addition to determining social influence values, the processor 220 may also determine a confidence level for one or more influence links 135 within the global social influence network 140. The confidence level of an influence link 135 represents the degree to which influence links 135 present within the global social influence network 140 are likely to be reflective of one individual's purchasing influence over another individual in reality. To determine a confidence level for an influence link 135, the processor 220 analyzes the number of times an influence link 135 was inferred between two customer identifiers versus the number of times in which the two customer identifiers co-appeared across the plurality of randomized samples 120. Confidence levels of some or all of the influence links 135 present within the global social influence network 140 may be included within reports 150 generated by the processor.

Reports 150 generated by the processor 220 may be stored within the system 200 in step 845 for later use. In one preferred embodiment, reports 150 generated by the processor 220 are stored within the processor 220. However, one of skill in the art will appreciate that reports 150 generated by the processor 220 may be stored anywhere within the system 200, including but not limited to, the non-transitory computer readable medium 230. Reports 150 generated by the processor 220 may be outputted to a user interface operably connected to the processor 220 or to an external computing device via a wired or wireless connection. Step 855 indicates the end of the post-processing stage.

It is understood that the programming instructions and programs discussed herein may be written in any suitable programming language including, but not limited to, C++, Stata, Python, or any other programming language or combination of programming languages. It is also understood that the present disclosure contemplates embodiments wherein certain programs disclosed herein may be run on a cloud computing platform, such as Amazon Web Services or any other suitable cloud hosting providers.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs which can also be referred to as programs, software, software applications, applications, components, or code, include machine instructions for a programmable processor, and can be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a computer readable medium that receives machine instructions as a computer-readable signal. The term “computer-readable signal” refers to any signal used to provide machine instructions and/or data to a programmable processor. To provide for interaction with a user, the subject matter described herein can be implemented on a computer having a display device, such as a cathode ray tube (CRT), liquid crystal display (LCD), light emitting diode (LED) monitor for displaying information to the user and a keyboard and a pointing device, such as a mouse or a trackball, by which the user may provide input to the computer. Other kinds of devices can be used to provide interaction with a user as well. For example, feedback provided to the user can be any form of sensory feedback, such as visual feedback, auditory feedback, or tactile feedback; and input from the user may be received in any form including, but not limited to, acoustic, speech, or tactile input. The subject matter described herein can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described herein, or any combination of such back-end, middleware, or front-end components. The components of the system can be interconnected by any form or medium of digital data communication, such as a communication network. Examples of communication networks include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or flowcharts described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

What is claimed is:

1) A method for inferring social influence networks from transactional data, said method comprising the steps of:
receiving, by a processor, a transactional data set,
wherein the transactional data set comprises a plurality of transaction entries,
each transaction entry having a customer, a product, and a transaction time,
translating, by the processor, the transactional data set into an internal data set comprising a plurality of internal entries corresponding to the plurality of transaction entries,
each internal entry of the plurality of internal entries having a customer identifier with a product identifier and a transaction time identifier associated therewith;
determining, by the processor, a sample number (S) and a sample size (K), drawing, by a plurality of computer nodes, a plurality of randomized samples from the internal data set equal to S,
wherein each sample of the plurality of randomized samples has a number of different customer identifiers therein equal to K and the product identifier and transaction time identifiers associated with the number of different customer identifiers;
creating, by the plurality of computer nodes, a social influence network for each sample of the plurality of randomized samples,
wherein the social influence network of each sample has zero or more influence links extending between the number of different customer identifiers within the sample,
the zero or more influence links being based on the customer identifiers, product identifiers, and transaction time identifiers within the sample; and
aggregating, by the processor, the social influence network of each sample of the plurality of randomized samples into a global social influence network.

2) The method of claim 1, wherein the global social influence network has all of the influence links of each social influence network therein.

3) The method of claim 1, wherein S is determined based on the number of different customer identifiers within the internal data set, K, and a defined average number of times in which a first customer identifier co-appears with a second customer identifier across the plurality of randomized samples.

4) The method of claim 1, wherein K is determined based on the number of different customer identifiers within the internal data set.

5) The method of claim 1, wherein the number of different customer identifiers of each sample of the plurality of randomized samples is drawn without replacement.

6) The method of claim 1, wherein the number of different customer identifiers across the plurality of randomized sample is drawn with replacement.

7) The method of claim 1, further comprising the steps of:
scheduling, by the processor, the plurality of computer nodes to draw a plurality of randomized samples equal to S; and
scheduling, by the processor, the plurality of computer nodes to create a social influence network for each sample within the plurality of randomized samples.

8) The method of claim 1, further comprising the steps of:
analyzing, by the processor, the global social influence network;
determining, by the processor, an influence value for each customer identifier based on the influence links within the global social influence network; and
generating, by the processor, a report.

9) The method of claim 8, wherein the report comprises the influence value of a customer identifier within the internal data set.

10) The method of claim 8, wherein the report is generated based on the number of influence links extending between customer identifiers.

11) A method for inferring social influence networks from transactional data, said method comprising the steps of:
receiving, by a processor, a transactional data set,
wherein the transactional data set comprises a plurality of transaction entries,
each transaction entry having a customer, a product, and a transaction time;
translating, by the processor, the transactional data set into an internal data set comprising a plurality of internal entries,
each internal entry of the plurality of internal entries having a customer identifier with a product identifier and a transaction time identifier associated therewith;
determining, by the processor, a sample number (S) and a sample size (K), wherein S is determined based on the number of different customer identifiers within the internal data set, K, and a defined average number of times in which a first customer identifier co-appears with a second customer identifier across the plurality of randomized samples, and wherein K is determined based on the number of different customer identifiers within the internal data set;
scheduling, by the processor, a plurality of computer nodes to draw a plurality of randomized samples equal to S,
drawing, by the plurality of computer nodes, a plurality of randomized samples from the internal data set equal to S,
wherein each sample of the plurality of randomized samples comprises a number of different customer identifiers therein equal to K and the product identifiers and transaction time identifiers associated with the number of different customer identifiers;
creating, by the plurality of computer nodes, a social influence network for each sample of the plurality of randomized samples,
wherein the social influence network of each sample has zero or more influence links extending between the number of different customer identifiers within the sample,
the zero or more influence links being based on the customer identifiers, product identifiers, and transaction time identifiers within the sample; and
aggregating, by the processor, the social influence network of each sample of the plurality of randomized samples into a global social influence network,
wherein the global social influence network has the influence links of the social influence network of each sample therein.

12) The method of claim 11, wherein the number of different customer identifiers of each sample of the plurality of randomized samples is drawn without replacement.

13) The method of claim 11, wherein the number of different customer identifiers across the plurality of randomized samples is drawn with replacement.

14) The method of claim 11, further comprising the steps of:
analyzing, by the processor, the global social influence network;
determining, by the processor, an influence value for each customer identifier based on the influence links within the global social influence network; and
generating, by the processor, a report.

15) The method of claim 14, wherein the report comprises the influence value of a customer within the transactional data set.

16) The method of claim 14, wherein the report comprises the influence value of customer identifier within the internal data set.

17) The method of claim 14, wherein the report is generated based on the number influence links extending between customer identifiers.

18) A system for inferring social influence networks from transactional data, said system comprising:
a processor;
a plurality of computer nodes operably connected to the processor; and
a non-transitory computer-readable medium coupled to the processor having instructions stored thereon, which, when executed by the processor, cause the system to perform operations comprising:
receiving, by the processor, a transactional data set,
wherein the transactional data set comprises a plurality of transaction entries,
each transaction entry having a customer, a product, and a transaction time,
translating, by the processor, the transactional data set into an internal data set comprising a plurality of internal entries,
each internal entry of the plurality of internal entries having a customer identifier with a product identifier and a transaction time identifier associated therewith;
determining, by the processor, a sample number (S) and a sample size (K);
drawing, by the plurality of computer nodes, a plurality of randomized samples from the internal data set equal to S,
wherein each sample of the plurality of randomized samples has a number of different customer identifiers therein equal to K and the product identifiers and transaction time identifiers associated with the number of different customer identifiers;
creating, by the plurality of computer nodes, a social influence network for each sample of the plurality of randomized samples,
wherein the social influence network of each sample has zero or more influence links extending between the number of different customer identifiers within the sample,
the zero or more influence links being based on product identifiers and transaction time identifiers within the sample; and
aggregating, by the processor, the social influence network of each sample of the plurality of randomized samples into a global social influence network.

19) The system of claim 18, further comprising instructions stored on the non-transitory computer-readable medium, which, when executed by the processor, cause the processor to perform operations comprising:
analyzing the global social influence network;
determining an influence value for each customer identifier based on the influence links within the global social influence network; and
generating a report.

20) The system of claim 18, wherein S is determined based on the number of different customer identifiers within the internal data set, K, and a defined average number of times in which a first customer identifier co-appears with a second customer identifier across the plurality of randomized samples, and wherein K is determined based on the number of different customer identifiers within the internal data set.
